(19) United States
(12) Patent Application Publication
(10) Pub. No.: US 2010/0176171 A1
(43) Pub. Date: Jul. 15, 2010

(54) UTILITY PACK

(75) Inventors: Christopher R. Araujo, Hillsboro, OR (US); JinHwan Kim, Seoul (KR); SooYoung Baik, Seoul (KR)

Correspondence Address: Schwabe Williamson & Wyatt;PACWEST CENTER, SUITE 1900, 1211 SW FIFTH AVENUE, PORTLAND, OR, 97204, US

(73) Assignee: COLUMBIA SPORTSWEAR NORTH AMERICA, INC., Portland, OR (US)

(21) Appl. No.: 12/686,328

(22) Filed: Jan. 12, 2010

Related U.S. Application Data
(60) Provisional application No. 61/144,116, filed on Jan. 12, 2009.
(60) Provisional application No. 61/254,361, filed on Oct. 23, 2009.

(51) Int. Cl. A45F 5/00; B23P 11/00; B32B 1/08

(52) U.S. Cl. 224/600; 29/428; 428/36.4

(57) ABSTRACT

Utility packs having a flexible frame system are disclosed and described herein. A plurality of flexible frame members engage guides in the pack body to provide the pack with a resilient structure, and to further provide content protection and accessibility. Packs in accordance with various embodiments may also include a floating coupling between the shoulder harness and the pack body to enhance freedom of movement of the wearer. Embodiments may also include flexible frame members directly coupled to a waist harness to shift pack loads to the wearer's waist. Finally, a unique structure forming rod is disclosed which includes an outer member and inner member that gives items structure, durability, flexibility and resiliency.

### CROSS REFERENCE TO RELATED APPLICATIONS

The present application claims priority to U.S. Provisional Application No. 61/144,116, filed Jan. 12, 2009, entitled “Utility Pack,” the entire disclosure of which is hereby incorporated by reference in its entirety, and U.S. Provisional Application No. 61/254,361, filed Oct. 23, 2009, entitled “Utility Pack,” the entire disclosure of which is hereby incorporated by reference in its entirety.

### TECHNICAL FIELD

Embodiments of the present invention relate generally to soft sided utility packs, and in particular to a pack with a structure forming flexible frame system that can provide the pack with structural definition, integrity, and form, and in various embodiments may also improve load control and upper body movement.

### BACKGROUND

Current backpacks generally come in two forms, soft sided packs and hard sided packs. Hard sided packs are bulky, heavy and generally not conducive to many of the activities for which backpacks and other utility packs are used (e.g. outdoor recreation). Soft sided packs typically include a frameless body, or in some instances include an integrated back frame. In either case, soft sided packs are generally made wholly of one or more pliable materials, which do not contribute significantly to giving the pack a discernable form or structure. The structureless nature of these soft sided packs does not provide adequate protection to the stowed items, and can make loading and/or viewing contents difficult. These problems persist even in soft sided packs that have a back frame structure integrated therein. Current soft sided packs also do not provide satisfactory load support, leading to undue stress applied to certain areas of the pack (e.g. seams), which exacerbates the potential for failure.

Current packs also have a shoulder harness that includes straps that are directly fastened to the pack, usually by stitching, rivets or clevis pins. This connection creates several undesirable effects. First, it tends to concentrate the majority of the pack load on the shoulders of the wearer, as opposed to the hips of the wearer, when a hip or waist strap/belt is incorporated. Second, it tends to keep the relationship between the upper portion of the pack and the wearer's back generally constant (i.e. as the wearer's shoulders move, the pack upper portion closely tracks such movement), which restricts movement of the wearer. Third, the direct fastening also limits the amount of adjustment that can be made to the positioning of the pack relative to the wearer's back, and is generally limited to lengthening or shortening the shoulder strap connection with a lower portion of the pack.

Structure forming frames for bags, tents, etc. have conventionally been made of materials such as wood, glass-filled nylon, steel, aluminum, spring steel, spring wires, fiber glass, fiberglass reinforced plastic, or plastic (most generally, polyvinyl chloride (PVC)). For those applications where the frame must be bent or contorted, a certain elasticity is required. Such elasticity depends on the contents and formation of the material in the structure forming frame.

Fiber-reinforced plastic (“FRP”) is a common component used for certain frames, and is made of a synthetic resin-based composite material reinforced by fiberglass or carbon fiber. FRP is light and has excellent mechanical strength, strong resistance to corrosion, and good moldability. Therefore, FRP is often used for applications such as structure forming frames, fishing rods, safety helmets, etc. FRP (and some other aforementioned materials), however, generally has a low level of elasticity, and an external impact or scratch, if any, tends to break or bend them.

In the case of tent poles made of FRP, for example, aging, long use or careless treatment result in the development of cracks and breaks. Once broken, tent poles are fragmented into a number of fiber bundles, which have sharp edges, due to material characteristics. In other words, excessive force during use may break tent poles, and the resulting sharp edges may hurt the user's hands or other parts. The edges may also cut or tear the fabric of tents, bags, packs, or clothing. Debris may peel off the surface of poles when installed or disassembled, and the debris may adhere to the user's hands and damage the skin. Frame members made of nonmetallic materials also have a problem of high manufacturing cost, and often once they are bent, they cannot regain their original shape, thus losing their functionality.

### BRIEF DESCRIPTION OF THE DRAWINGS

Embodiments of the present invention will be readily understood by the following detailed description in conjunction with the accompanying drawings. Embodiments of the invention are illustrated by way of example and not by way of limitation in the figures of the accompanying drawings.

FIG. 1 illustrates a utility pack in accordance with various embodiments of the invention;

FIG. 2 illustrates a utility pack in accordance with various embodiments of the invention;

FIG. 3 illustrates a utility pack in accordance with various embodiments of the invention;

FIG. 4 illustrates a utility pack in accordance with various embodiments of the invention;

FIG. 5 illustrates a utility pack in accordance with various embodiments of the invention;

FIGS. 6A and 6B illustrate front and side views of a utility pack in accordance with various embodiments of the invention;

FIG. 6C illustrates a back view of a utility pack with the shoulder straps or harness removed in accordance with various embodiments of the invention;

FIG. 6D illustrates a portion of a shoulder harness adapted to couple to a utility pack in accordance with various embodiments of the invention;

FIGS. 7A-7D illustrate various views of a semi rigid shoulder harness support adapted for use in a utility pack in accordance with various embodiments of the invention;

FIGS. 8A-8C illustrate back views of a utility pack in accordance with various embodiments of the invention;

FIGS. 9A and 9B illustrate an enlarged portion of a waist harness utility pack interface in accordance with various embodiments of the invention;

FIGS. 10A-10B illustrate a utility pack and associated components in accordance with various embodiments of the invention;

FIGS. 11A-11C respectively illustrate front, side and back views of a utility pack in accordance with various embodiments of the invention;

FIG. 12 illustrates a perspective view of a flexible frame member in accordance with various embodiments; and

FIG. 13 illustrates a perspective view of a flexible frame member in accordance with various embodiments.

### DETAILED DESCRIPTION OF EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

The description may use perspective-based descriptions such as up/down, back/front, and top/bottom. Such descriptions are merely used to facilitate the discussion and are not intended to restrict the application of embodiments of the present invention.

For the purposes of the present invention, the phrase “A/B” means A or B. For the purposes of the present invention, the phrase “A and/or B” means “(A), (B), or (A and B).” For the purposes of the present invention, the phrase “at least one of A, B, and C” means “(A), (B), (C), (A and B), (A and C), (B and C), or (A, B and C).” For the purposes of the present invention, the phrase “(A)B” means “(B) or (AB)”, that is, A is an optional element.

Various operations may be described as multiple discrete operations in turn, in a manner that may be helpful in understanding embodiments of the present invention; however, the order of description should not be construed to imply that these operations are order dependent.

The description may use the phrases “in an embodiment,” or “in various embodiments,” which may each refer to one or more of the same or different embodiments. Furthermore, the terms “comprising,” “including,” “having,” and the like, as used with respect to embodiments of the present invention, are synonymous.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

The term “harness” is used generally to include one or more components of a system that is configured to couple a backpack to a wearer's body. A “shoulder harness” is defined to include a harness having one or more straps that are adapted to engage one or both of the wearer's shoulders. A “waist harness” is defined to include a harness configured to at least partially encircle a wearer's waist and/or torso region.

The term “soft sided pack” is defined generally as a pack that has a body portion that is at least partially constructed of a pliable material such as cloth, leather, synthetic leather, nylon, cordura, and other durable fabrics or materials.

The term “pack back side” is defined to be the portion or side of the pack generally engages the wearer's back. The term “pack front side” is defined to be the portion of the pack body that generally faces away from the wearer's back.

In various embodiments a utility pack, such as a backpack, is provided that includes flexible frame system that may be integrated with a soft sided pack (including a back frame based pack or a frameless pack) to help define the shape and structure of the pack body. Such a structure forming frame system may include one or more flexible frame members made of a material that is flexible enough to allow the frame members to be bent and integrated into the pack, yet rigid and reflexive enough that when in place the frame members give the pack a desired shape or form.

In various embodiments, the flexible frame member may be a multi-structured rod member having strength sufficient to maintain the shape of a pack or other item (e.g. a tent), as well as high elasticity, good durability, excellent restoration force, and lightness. In accordance with an embodiment of the present invention, the multi-structured rod member may includes an outer rod having a hollow portion, and one or more inner rods made of a fiber-reinforced composition inserted into the hollow portion.

In various embodiments the flexible frame members may also be of a sufficient rigidity to provide protection to the stowed cargo, and may also have a memory response such that upon deflection of the frame, it will reassume its expanded configuration and thereby reestablish the desired form.

In various embodiments, a shoulder harness may be movably coupled to one or more of the flexible frame members along a portion that extends along part of the pack back side. Such a coupling can allow the upper portion of the pack to move relative to changes in the positioning of the wearers shoulders, whether it be vertically, laterally and/or rotationally, in order to allow for more unrestricted upper body movement during certain activities. For example, when a user moves from the upright position to a hunched position while riding a bicycle, the movable coupling of the harness to the flexible frame components can allow the pack to shift and/or float relative to the shoulders and back. Such a coupling may also provide a suspension effect for the pack, while maintaining stability and control of the load. Further, the movable or “floating” coupling may allow for dynamic adjustment of the pack positioning relative to the wearer's back in order to accommodate different body sizes or to strategically position the load for a given activity.

In various embodiments, the flexible frame members may be connected to a waist harness in order to improve structural support and where a shoulder harness is used, shift the pack load from the wearer's shoulders more to the wearer's hips. This load shifting can reduce strain and fatigue on the wearer's shoulders, and further improve the range of movement of the wearer's upper body during activities such as biking, hiking, running, skiing, climbing, paddling, hunting and fishing. In some embodiments, one or more of the flexible frame members may extend along the back side of the pack relative to the wearer's back and have ends that extend into and/or along at least a portion of the waist harness.

In various embodiments, the flexible frame members may be integrated with the pack at the point of manufacture. In other embodiments, the user may couple the flexible frame members to the pack via designated couplers. In various embodiments, the frame members may be wholly external, partially external or wholly internal to the pack material, depending on a variety of factors, including, but not limited to aesthetics, desired degree of protection, exposure to water and dirt, material specifications, and the like. Further, the flexible frame members may be partially exposed though the use of multiple guides, receivers or member couplers.

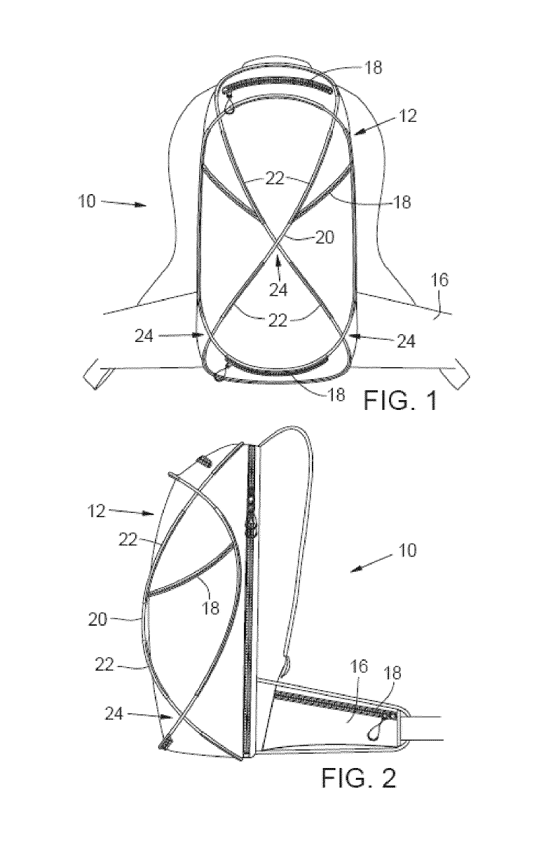

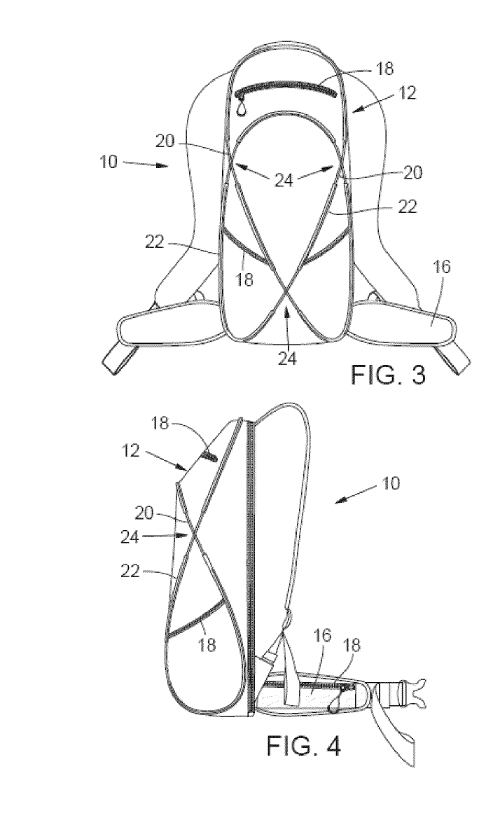

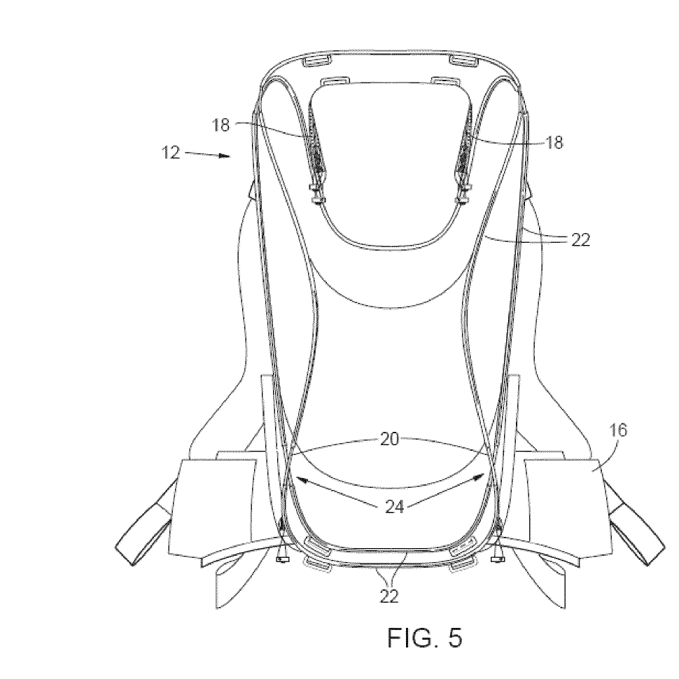

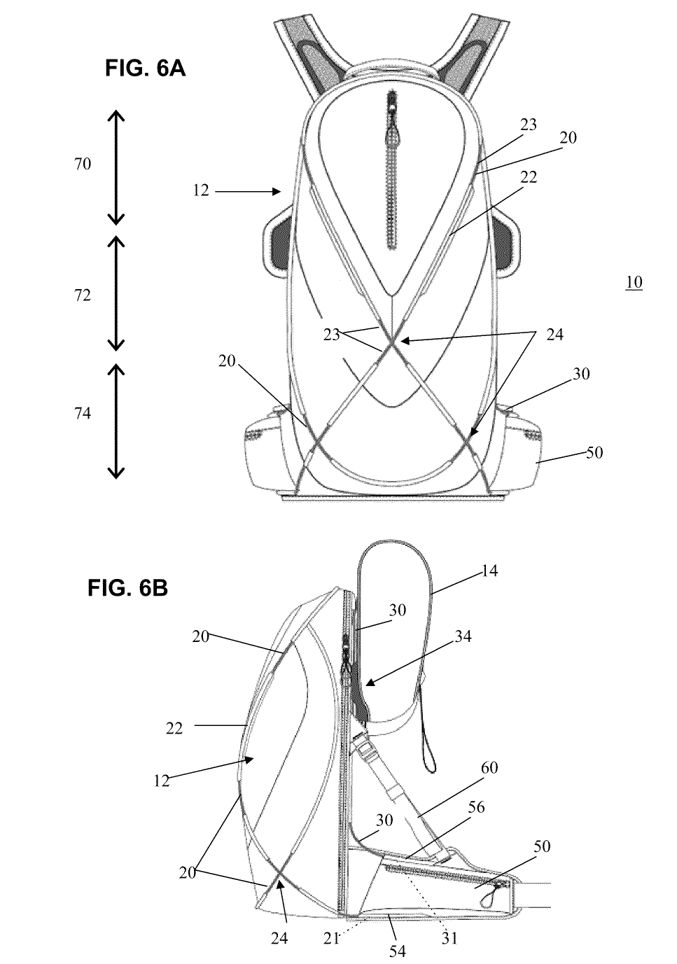

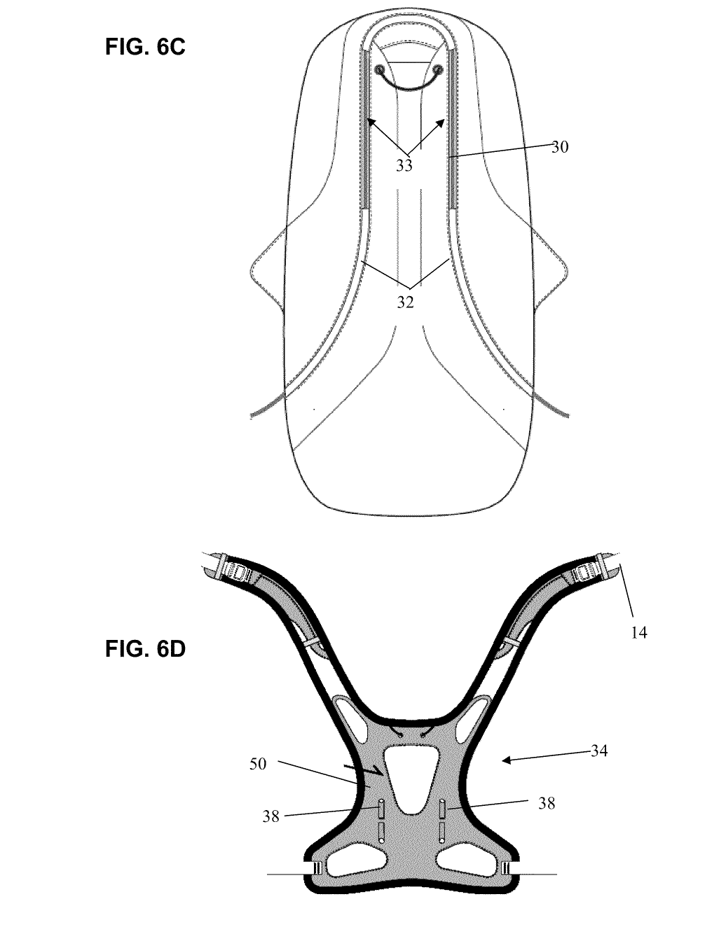

FIGS. 1-2 illustrate respective front and side views of an example utility pack having a structure forming flexible frame system in accordance with various embodiments. FIGS. 3-4 illustrate respective front and side views of another example utility pack having a structure forming flexible frame system in accordance with various embodiments. FIG. 5 illustrates a third example utility pack having a structure forming flexible frame in accordance with various embodiments.

As illustrated, a soft sided pack 10 may include a pack body 12, and a shoulder harness including shoulder straps 14 and a waist harness 16 coupled to the body 12. In various embodiments, a variety of other body coupling configurations or combinations may be used to allow a user to carry the pack (e.g. single shoulder strap, no shoulder straps, etc.). Pack body 12 may include a variety of access ports 18, which gives the user access to various pockets or internal compartments of the Pack 10. Access ports 18 may be closeable via a variety of closure mechanisms such as zippers, Velcro, snaps, buttons and the like.

Pack 10 may further include one or more structure forming flexible frame members 20 that are adapted to engage the pack body 12 via one or more flexible frame couplers or guides 22. In various embodiments, guides 22 may be loop guides, grommets, hooks or any other coupling/guide arrangement in which the flexible frame members 20 can engage to give the pack body 14 structural definition. As illustrated, tunnel guides, for example, may be sewn to the body material and have openings sized to allow the flexible frame member to pass there through. In various embodiments, the guides 22 may be internal or external to the body 12, and may further be adapted to encompass all or a part of the flexible frame members 20.

With the flexible frame members 20 inserted in the guides 22, the reflexive tension in the flexible frame members 20 may give the soft sided pack body 12 a desired form and structure. Such a structure may help protect the cargo, make loading the pack easier, and/or help balance the displacement of the load. In various embodiments, one or more flexible frame members 20 may be used to provide a desired shape and accommodate different sizes and configurations. The flexible frame members 20 may be integrated throughout the pack body 12 in a pattern generally defined by the guides and having ends that are configured to terminate against each other to thereby form a continuous loop. Whereas in other embodiments, the flexible frame member 20 may engage the guides 22 and have opposing ends that terminate at designated receivers disposed on the pack body or a harness.

In various embodiments, the guides may be configurable by the user so as to alter the structural form taken by the pack body once the structure forming flexible frame members engage the couplers. In such cases, the guides may be detachably coupled to the body of the pack or positioned on guide tracks to allow for guide repositioning.

In various embodiments, the structural rigidity and support of the pack body may be enhanced by having the flexible frame members form one or more cross up points or “X points” 24. X points 24 may allow the body of the back to better resist lateral and vertical deflection caused by external and internal forces to the pack body. In addition to resisting structural collapse/deformation, including X points 24 further helps enhance structural responsiveness of the flexible frame members to deflections.

In various embodiments, a portion of the frame members may circumnavigate all or a portion of an access port 18 in such a manner that undoing of the access port closure mechanism may bias the access port to either an open or closed position.

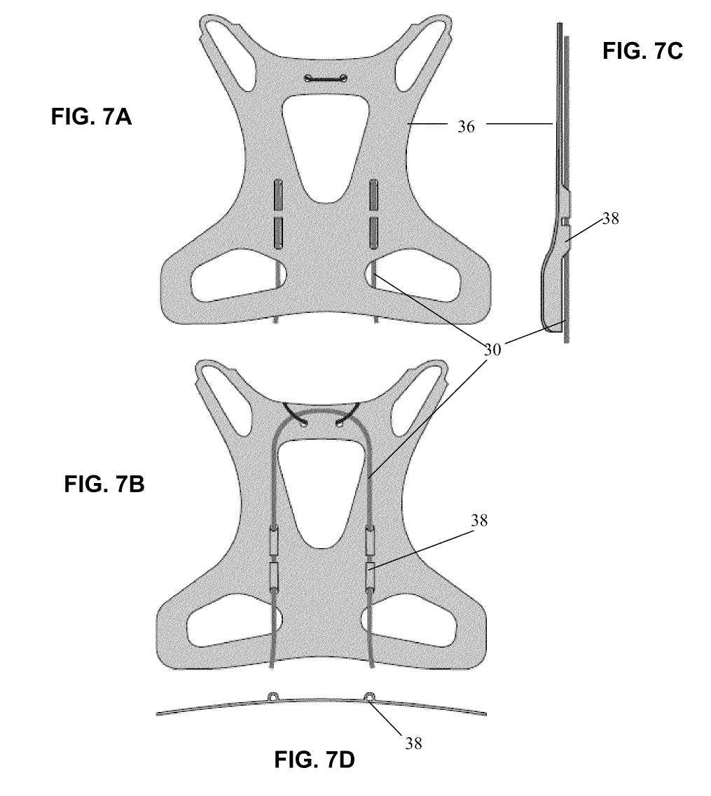

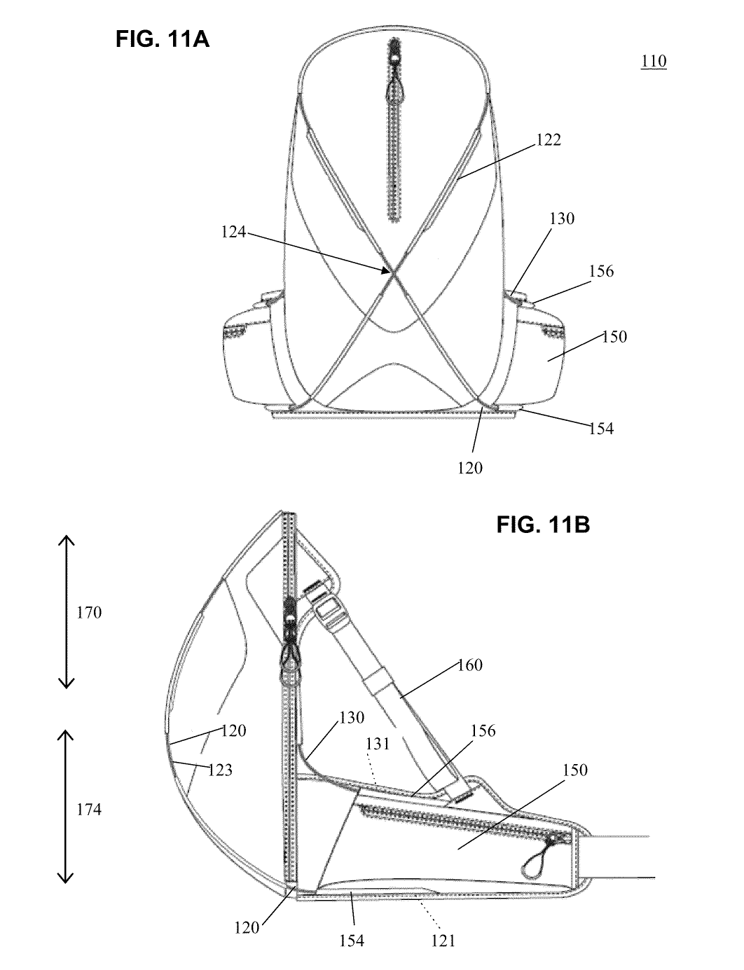

FIGS. 6-10 Illustrate embodiments of a soft sided pack, where a shoulder harness is coupled to one or more generally flexible frame members extending along the pack back side. As discussed herein, a slidable connection between the shoulder harness and the flexible frame members can allow the pack to move relative to the shoulder harness and thus the wearer's shoulders. FIGS. 11A-11C illustrate a pack having flexible frame members and other structural support which eliminates the need for a shoulder harness, and yet still provide support for the pack during use.

FIGS. 6A and 6B illustrate respective front and side views of a soft sided utility pack in accordance with various embodiments. As illustrated, pack 10 may have a soft sided body 12 made of a generally pliable material, as described above. One or more flexible frame members 20 may traverse portions of the pack body to provide structural definition and integrity to the pack 10. Flexible member guides 22 may be strategically positioned about the body 12 of the pack 10 to allow for integration of the flexible frame members 20 with the pack 10. As illustrated, portions of the flexible frame members 20 may be exposed a desired amount, for example, by exposed lengths 23. Further, a plurality of X points 24 may be included to improve structural integrity of the pack.

For purposes of discussion with respect to the illustrated embodiments, the pack may be generally divided into three portions, an upper pack portion 70, a middle or central pack portion 72 and a lower pack portion 74. For the purpose of example, the pack portions have been broken down roughly into thirds, but other dimensional break downs are possible, and the invention is not limited to the forgoing.

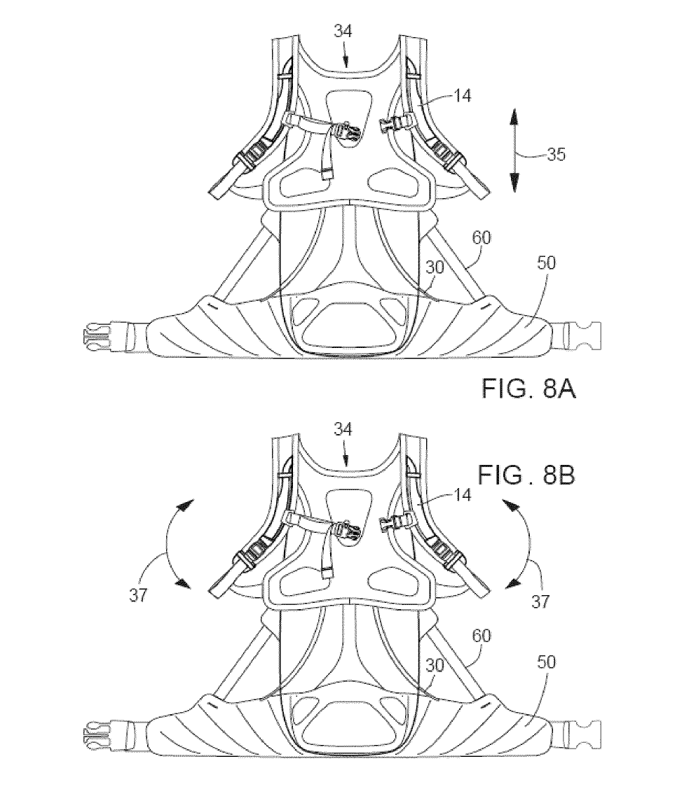

A shoulder harness 34 may be coupled to pack body 12 at or near an upper pack portion 70 or a middle pack portion 72. Shoulder harness 34 may include a shoulder harness body 36 (see FIGS. 6D and 7A) and shoulder straps 14. Pack 10 may also have a waist harness 50 coupled to pack 10 and adapted to generally encircle a wearer's waist. FIG. 6C illustrates a back view of the pack 10 of FIGS. 6A and 6B without the shoulder harness 34 coupled thereto. FIG. 6D illustrates a rear view of the shoulder harness 34. FIGS. 7A-7D illustrate views of the shoulder harness body 36 of FIGS. 6A-6D.

As illustrated, pack 10 may include one or more rear flexible frame members 30 that traverse at least a portion of the pack back side. As illustrated, a single rear flexible frame element 30 extends generally upward from a lower portion of one side of the pack, loops at the upper pack portion 70 and extends generally downward towards the opposite side lower pack portion 74. In other embodiments, more than one rear flexible frame member may be used on the rear of the pack. Rear flexible frame members 30 may engage rear pack guides 32 in order to maintain the desired flexible frame member configuration about the pack back side. Rear pack guides 32 are sized to leave exposed rear frame portions 33, which may generally run vertically along the pack back side.

The shoulder harness body 36 may include harness guides 38 that are configured to engage exposed rear frame portions 33 of rear flexible frame members 30. Harness guides 38 may be sized to allow for sliding engagement between the rear flexible frame members 30 and the harness body 36. Such a coupling allows for limited movement of the shoulder harness 34 relative to the upper portion of the pack, which can result in a “floating”-type effect.

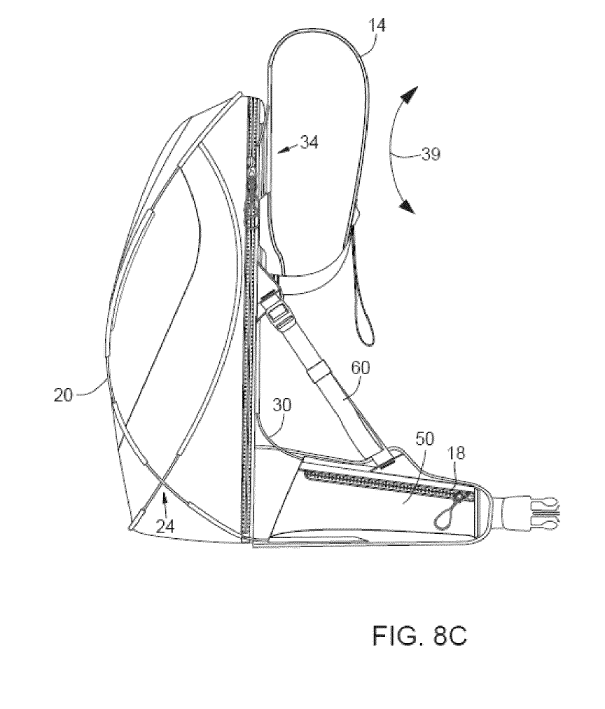

FIGS. 8A, 8B and 8C illustrate an example shoulder harness coupled to the flexible frame members in accordance with various embodiments, and further shows the various degrees of movement that may be achieved by way of the floating effect caused by the shoulder harness coupling described above.

As illustrated in FIG. 8A, the slidable coupling of the harness body 36 with the exposed portions 33 of rear flexible frame members 30 allows for vertical movement of the harness 34 relative to the pack 10, as illustrated by action line 35. Thus, for example, when a wearer reaches above his or her head, the pack shoulder harness can move up or down relative to the pack. Further, such a coupling allows for the pack to adjustably fit wearers having different torso lengths as the shoulder harness may freely move up or down to adjust accordingly. In some embodiments, once adjusted, a stop or other locking mechanism may be actuated to hold the pack in the desired position on the rear flexible frame members.

FIG. 8B illustrates rotational movement 37 of the shoulder harness 34 relative to the pack 10, which also may be allowed by virtue of the slidable coupling between the harness body 36 and the rear flexible frame members 30. The rotational movement may be allowed due in part to a combination of the independent slidable engagement of the harness guides 38 with the exposed portions 32 of rear flexible frame members 30, as well as the ability of the rear flexible frame members 30 to flex/deflect from side to side. Thus, for example, if the wearer is bending from side to side or the shoulders are moving in a non-uniform manner (e.g. a one arm reaching motion), the pack may move less from the vertical or other reference plane than the wearer's shoulders. In various embodiments, the harness guides 38 may also be flexible so as to allow for some twisting movement relative to the flexible frame members (e.g. made of fabric).

FIG. 8C illustrates a side view of a pack in accordance with various embodiments, illustrating front to back movement 39 of the shoulder harness relative to the pack body. Shoulder harness 34 is coupled to flexible frame members 30 by harness guides 38 in the harness body 36. Such a coupling may allow for the wearer to have a greater degree of forward shoulder movement by virtue of the shoulder harness not being connected to a single position on the upper portion of the pack, as is typical in current pack designs. For example, when a wearer hunches over to ride a bicycle, a greater degree of movement may be allowed without restriction than in current packs.

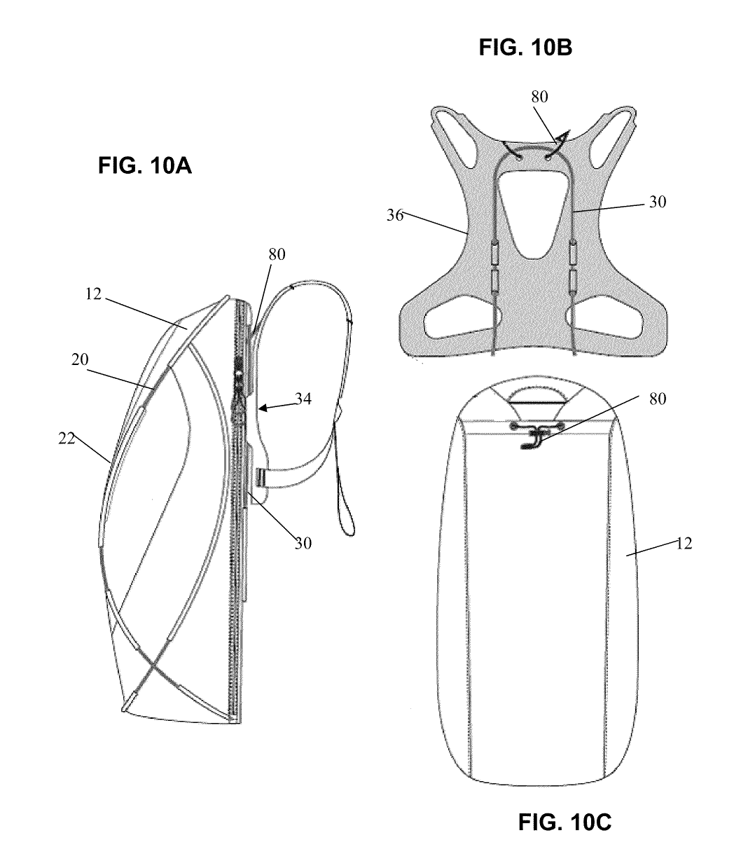

As illustrated in FIGS. 10A, 10B and 10C, an upper limiting strap 80 may by disposed on the pack body 12 and/or the shoulder harness 34. Limiting strap 80 connects the upper pack portion to the shoulder harness and serves to limit the amount of movement allowed by the upper pack portion relative to the wearer's shoulders. Limiting strap 80 may also provide for additional support during extreme movements. As illustrated, in one embodiment, the limiting strap 80 may be adjustably coupled to the upper pack portion 70 and further coupled to the shoulder harness body 36.

In various embodiments, limiting strap 80 may be a resilient cord or strap such as a bungee type cord or strap. In addition to providing limits to pack movement, resiliency in the strap can help pull the upper portion of the pack back towards the wearer's shoulders in order to ensure a generally conforming fit of the pack to the wearer's back. In various embodiments, the limiting strap 80 may be adjustable to control the amount of allowable movement.

While a shoulder harness has been shown and described in the illustrated embodiments, in various embodiments, individual shoulder straps may engage one or more flexible frame members to accomplish the floating type coupling between the wearer's shoulders and the upper portion of the pack. Further, in various embodiments, shoulder harness body 36 may be made of the same or similar material as the shoulder straps 14 or may be made of a more rigid material that will provide additional structural support and integrity for the shoulder straps and other harness components. In various embodiments, the shoulder harness body 36 may be made of semi-rigid material such as stamped and molded Polyethylene (PE).

While some embodiments have been described as having flexible frame members serving as the portions which engage the harness guides 38 of harness body 36, in other embodiments, one or more tracks or other more rigid members separate and apart from the flexible frame member components may be used to interface with the shoulder harness to create the floating effect.

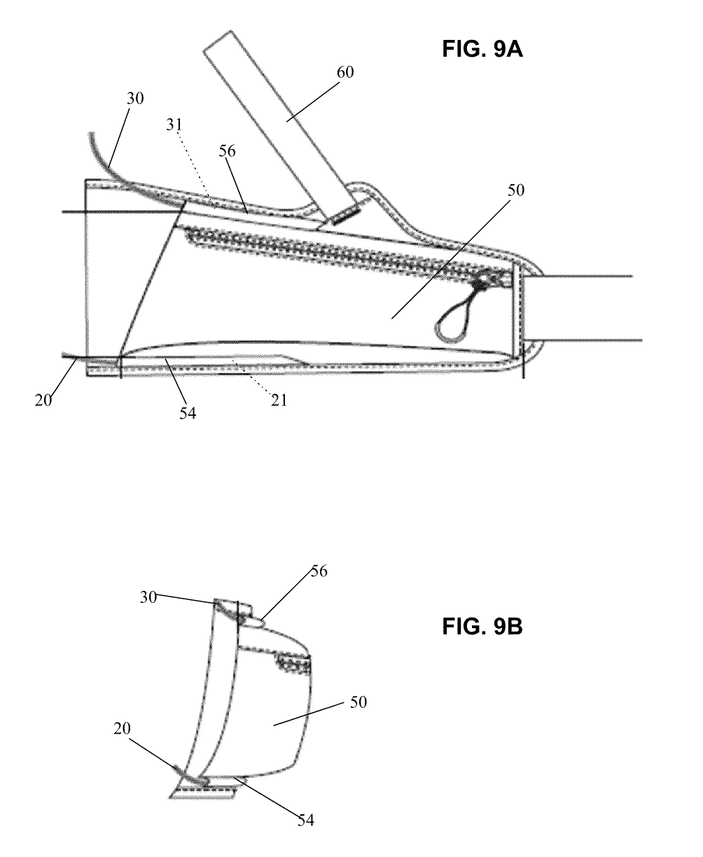

As further illustrated in FIGS. 6-8, and in greater detail in FIGS. 9A and 9B, the flexible frame members may directly engage a waist harness 50 of the pack 10. In one embodiment, the waist harness 50 may be coupled to a lower pack 74, and further adapted to wrap around and adjustably couple to the wearer's waist. Flexible frame members 20 and/or rear flexible frame members 30 may include end portions 21 and 31 that engage waist harness receivers 54 and 56 respectively.

In the illustrated example, front and/or side flexible frame members 20 have ends 21 which may engage lower belt receiver 54 and extend along the waist harness 50 a sufficient distance to be both sufficiently retained in waist harness receiver 54 to resist unintentional disengagement and to transfer pack load to the wearer's waist. Likewise, ends 31 of rear flexible frame members 30 can engage upper waist harness receivers 56 a sufficient distance to be adequately retained and help transfer pack load to the wearer's hips. In one embodiment, the length of the receivers may be greater than or equal to one inch and extend longitudinally along the waist harness. The amount of engagement may be adjustable as desired by the user. Because the foregoing is used as an example, the terminus ends may be connected to the waist harness in a variety of ways and at various points along the waist harness.

Having the flexible frame member ends directly engage the waist harness helps direct the pack load to the waist harness and the wearer's hips, thereby relieving load from the shoulders imposed by the shoulder harness. In some embodiments, this connection to the waist harness further allows the shoulder harness to better move relative to the rear flexible frame members, thus enhancing the freedom of movement benefits generated by the floating type upper pack portion.

As further illustrated in FIGS. 6-9, cross members 60 may be coupled between the pack body 12 and the waist harness 50. As illustrated cross members 60 may connect to the pack body in the central pack portion 72, but the invention is not so limited. Coupling of cross member 60 to the waist harness 50 may help resist undesired movement of the pack away from the middle to lower portion of a wearer's back (e.g. lumbar region) and/or side to side shifting. Cross members 60, in conjunction with the flexible frame member engaged waist harness help to provide better pack load support, allows the upper portion of the pack body to have some degree of floating capability relative to the user's shoulders, while keeping the mid to lower portion of the pack relatively close to the wearer's lower back for suitable conformity during activity. The additional support and control provided by this fit not only reduces the restriction on the wearer for upper body movement, but can allow an enhanced activity level not allowed by traditional packs.

FIGS. 11A, 11B and 11C illustrate front, side and back views of a pack 110 in accordance with various embodiments. As illustrated, the pack 110 does not include a shoulder harness, but rather directly couples to a user's body principally by a waist harness 150. Similar to the embodiments described in FIGS. 6-10, pack 110 may include a plurality of flexible frame members (e.g. rear flexible member 130 and front and/or side flexible members 120) positioned to give structural dimension to the pack body 112. Opposing ends 121 and 131 of two or more flexible members 120 and 130 may engage waist harness 150 via waist harness receivers 154 and 156 respectively. Cross members 160 may couple to an upper pack portion 170 of pack 110 to provide additional support and maintain a desired relationship between the pack 110 and the wearer's lower back or lumbar region, regardless of the movement of the wearer's upper body.

By virtue of having flexible frame members engage the waist harness along with the cross support provided by the cross members, the pack load may be adequately supported and the pack may be coupled to the wearer's body, thereby relieving any coupling to the wearer's shoulders. In various embodiments, an additional torso strap (not shown) may be coupled to the upper portion of the pack and adapted to encircle the wearer's upper torso to limit movement of the upper pack portion 170 away from the wearer's back.

In various embodiments, the flexible frame members may be composed of a variety of materials, including but not limited to nylon, nylon composite, fiberglass, carbon fiber, and/or other materials that are flexible enough to be bent or otherwise contorted throughout the guides of the pack without breaking or kinking, and yet rigid enough to have a resulting tension that provides structural definition to the pack.

In various embodiments, the diameter of the flexible member may be selected depending on the material. In one embodiment, it has been found that a diameter of between 2 millimeters and 10 millimeters may provide the appropriate balance of flexibility and rigidity. In one embodiment, a diameter of about 5 millimeters provides a good balance between flexibility and rigidity.

In various embodiments the flexible frame member may be composed of a multi-piece or dual structured flexible member may be used. For example, a flexible frame outer member may include a hollow core, and one or more inner rods may be inserted therein. Such a mixing of composite materials can help improve the degree of bend radii, while also providing sufficient structural rigidity, form and shape resilience.

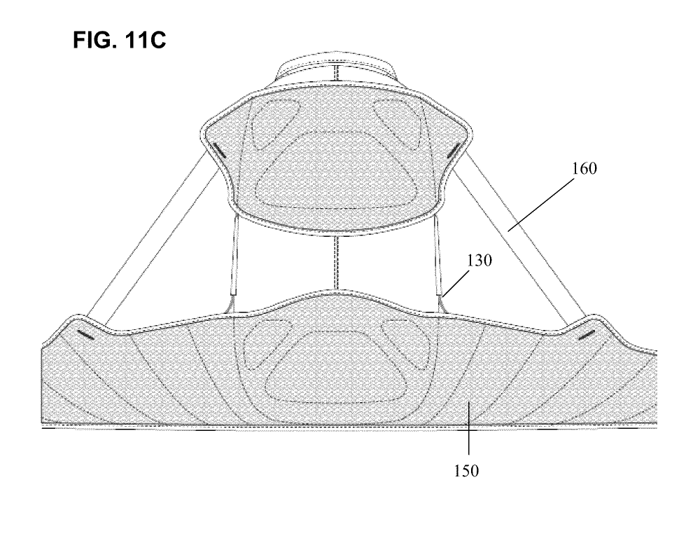

FIG. 12 illustrates a multi-structured flexible frame member in accordance with various embodiments. Flexible frame member 200 may include an outer rod 202 and an inner rod 204. In various embodiments, the outer rod 202 may be made of synthetic resin and the inner rod 204 made of fiber-reinforced resin. The outer rod 202 may be shaped to include a hollow portion to accommodate the inner rod 204, which may improve its elasticity and strength. In one embodiment, the outer rod 202 may be made of synthetic resin selected from the group consisting of nylon, polyurethane, polycarbonate, polyethylene, and polypropylene. The outer rod may be made through an extrusion molding or other conventional methods used to form high-molecular resin. An outer rod made of the above-mentioned high-molecular resins is advantageous in terms of cold resistance and toughness.

In one embodiment, nylon may be a preferable material for forming the outer rod because of its ability to resistant to breakage resulting from an external impact, scratches, and severe bending, and as well as its toughness and low temperature performance. In one embodiment, such nylon may be a polyamide resin, e.g. nylon 6, nylon 66, or nylon 6/66, having a content in the range of generally 97-99 wt %.

A 1-3 wt % of color pigment may be added to the synthetic resin outer rod. In this case, a minimum amount of color pigment may be used to make a transparent synthetic resin outer rod so that the inner rod, which is inserted into the outer rod, can be seen from outside. Alternatively, various colors of pigment may be added to manufacture a synthetic resin outer rod having distinctive visual characteristics. The same description holds not only when the synthetic resin outer rod is made of a nylon composition, but also when other resins (e.g. polyurethane, polyethylene, polypropylene, polycarbonate, etc.) are used.

In some embodiments, the outer rod may have an outer diameter of 5.00-5.12 mm. If the outer diameter is less than 5.00 mm, little improvement is made in connection with elasticity and strength. In some embodiments, the diameter may not exceed 5.12 mm. The hollow portion formed at the center of the outer rod preferably has a diameter in the range of 1.95-2.05 mm. In other embodiments, the outer rod diameter may be between 3 and 7 mm, and the inner hollow portion may be between 0.5 and 3.5 mm. In various embodiments, a ratio of outer diameter to inner hollow portion diameter may be between 2.2 to 2.8.

While these materials used for the outer rod/member are flexible, tough and durable, they are not well suited to regain their original shape once it is modified or otherwise manipulated. In particular, nylon tends to exhibit gradually weakening strength, etc., when used in circumstances with air or moisture for a long period of time. Therefore, an outer rod made of nylon may gradually lose its strength and elasticity as time elapses, and it also has weak restoration force. Inner member/rod 204 made of a fiber-reinforced composition may be inserted into the hollow portion of the outer rod 202 so as to prevent degradation of strength, elasticity, restoration force, etc. of the outer rod.

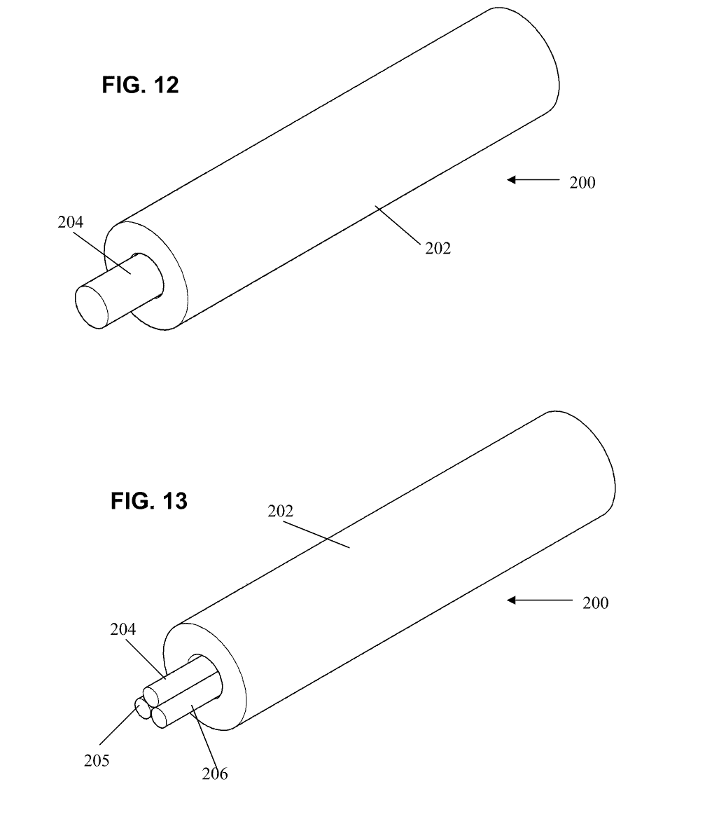

According to the example shown in FIG. 12, a single inner rod 204 is inserted into the hollow portion of the outer rod. According to an alternative embodiment, an example of which is shown in FIG. 13, more than one inner rods (e.g. 204, 205 and 206) may be combined and inserted into the hollow portion of the outer rod 202. In one embodiment, the multiple inner rods may have different colors so that, when inserted into an outer rod made of a transparent material, they provide an enhanced aesthetic appearance.

The fiber reinforcement material for the fiber-reinforced inner rod may be a single component of carbon fiber, aramid fiber, fiberglass, or titanium, or a mixture of the component with another resin. In one embodiment, fiberglass is preferably used, and may have a 60-65 wt % of fiberglass, 28-32 wt % of unsaturated polyester resin as a solvent, and 3-7 wt % of additive are mixed and subjected to extrusion molding. In various embodiments, the wt % of fiberglass is between approximately 50 wt % and 70 wt % in order to provide sufficient strength and moldability. In various embodiments, the thickness of extruded fibers may be between 270-330 tex. The solvent for the mixture may be an organic solvent, such as benzene, besides polyester, and unsaturated polyester is preferably used.

The inner rod made in accordance with various embodiments described herein may vary in diameters depending on the diameter of the outer rod hollowed portion, the number of inner rods used, and the desired characteristics. In one embodiment, the inner rod has a diameter of approximately 1.75-1.85 mm.

In one embodiment, fiberglass may be used as the fiber reinforcement material for the inner rod, as it is known to be generally weatherproof, durable, chemically stable, and nonflammable. Further, fiberglass has good resistance to degradation and a low tensile modulus. E(Electric)-fiberglass is the general type of fiberglass, and S(Strength)-fiberglass has good resistance to chemicals. R(Strength)-fiberglass has high strength, and C(Corrosion)-fiberglass has excellent corrosion resistance. There also exist ECR(Corrosion resistance E-Glass)-fiberglass and D(Dielectric)-fiberglass, the latter being low-insulation fiberglass used in radar facilities. AR(Alkali resistant)-fiberglass is used for concrete reinforcement by means of zirconium, and is classified as hollow fiberglass (E-fiberglass is typically used). The present invention is not limited to a specific type of fiberglass mentioned above, and E-fiberglass is preferably used.

In various embodiments, the solvent employed by the present invention is preferably unsaturated polyester resin, which facilitates the manufacture of products because it does not require high pressure when mixed with fiberglass and molded, and because it can be molded even at room temperature with the aid of an accelerator.

Various embodiments may also employ additives, such as a reinforcement material, a filler, a heat-resistant stabilizer, a weatherproof stabilizer, a slip agent, a nucleating agent, a fire retardant, color pigment, dye, etc. Examples of additives include talc, carbon fiber, calcium carbonate, clay, silica, alumina, carbon black, magnesium hydroxide, zeolite, barium sulfate, etc.

An example flexible frame member construction is described below, along with three current rod configurations and manufacture methods used for other applications.

Example flexible frame member in accordance with embodiments of the present invention:
Outer rod: 98 wt % of nylon 6 (PA6-3030S, Korea) and 2 wt % of color pigment are mixed and melted at 300° C. The resultant is subjected to extrusion molding to obtain a pipe-shaped outer rod having an outer diameter of 5.00 mm and a hollow portion diameter of 1.97 mm. The outer rod is then vacuum-dried. The dried outer rod is cut into pieces having a desired length according to usage
Inner rod: 35 wt % of polyester resin and 5 wt % of additive are melted/mixed at 190° C., and 60 wt % of fiberglass is separately fed and melted/mixed at 190° C. The resultant is extruded at a thickness of 300 tex to obtain a pellet-shaped blend, which is then vacuum-dried to obtain an inner rod having a diameter of 1.85 mm. The dried inner rod is cut into pieces having a desired length to generally match that or outer rod.
The inner rod or rods may be inserted into the hollow portion of the outer rod.

### Comparative Example 1

98 wt % of nylon 6 (PA6-3030S, Korea) and 2 wt % of color pigment are mixed and melted at 300° C. The resultant is extruded to mold a pellet-shaped rod which has an outer diameter of 5.00 mm and which has no hollow portion. The rod is vacuum-dried at 80° C., and is cut into pieces having the same length as in the case of the above-mentioned Embodiment.

### Comparative Example 2

98 wt % of nylon 6 (PA6-3030S, Korea) and 2 wt % of color pigment are mixed and melted at 300° C. The resultant is extruded to mold a pipe-shaped outer rod having an outer diameter of 5.00 mm and a hollow portion diameter of 1.97 mm. The outer rod is vacuum-dried at 80° C., and is cut into pieces having the same length as in the case of the above-mentioned Embodiment.

### Comparative Example 3

35 wt % of polyester resin and 5 wt % of additive are melted/mixed at 190° C., and 60 wt % of fiberglass is separately fed and melted/mixed at 190° C. The resultant is extruded to obtain a pellet-shaped blend, which is then vacuum-dried to obtain a rod having an outer diameter of 5.00 mm. The rod is vacuum-dried at 80° C. and is cut into pieces having the same length as in the case of the above-mentioned Embodiment.

The rods fabricated as described in the above Example embodiment and Comparative examples were strength tested using a “Durameter” instrument. The results are shown below, and confirm the superiority of the flexible frame members having a multi-core composition in accordance with various embodiments described herein:

| | Example | Comp. 1 | Comp. 2 | Comp. 3 |
|---|---|---|---|---|
| Strength(oz) | 11 | 6 | 5 | 6 |

In one embodiment, the outer rod may include an additive. The inner rod may be made of 60-65 wt % of fiber reinforcement material, 28-32 wt % of solvent, and 3-7 wt % of additive. The fiber reinforcement material may be any one selected from the group consisting of fiberglass, carbon fiber, and aramid fiber. The solvent may be polyester or benzene. The additive may be any one selected from the group consisting of a reinforcement material, a filler, a heat-resistant stabilizer, a weatherproof stabilizer, a slip agent, a nucleating agent, a fire retardant, color pigment, and dye. The outer rod may have an outer diameter of 5.00-5.12 mm. The hollow portion of the outer rod may have a diameter of 1.95-2.05 mm. The inner rod may have a diameter of 1.75-1.85 mm. One to four inner rods may be inserted into the hollow portion of the outer rod.

As mentioned above, the multi-structured rod member according to the present invention, which has an inner rod made of a fiber-reinforced material and inserted into the outer rod member, has the following advantages: it is ultra-light and has excellent elasticity, strength, and durability. It has good ability to regain its original shape. Even if the fiberglass is broken or if cracks develop, the outer synthetic resin prevents the sharp edges from being exposed to the outside, protecting not only the user, but also the material of the bag, pack, tent, etc.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

1. A utility pack, comprising:
a body made at least in part of a generally pliable material, the body having a back side and a front side;
a harness connected to the pack body and adapted to couple the pack to a portion of a wearer's body;
a first flexible frame member;
a plurality of guides disposed about the pack body and sized to couple the first flexible frame member to the pack body; and
wherein the first flexible frame member engages the plurality of guides to provide the pack with a desired structural form.

2. The utility pack of claim 1, further comprising a second flexible frame member having a portion of which is coupled to the pack back side, the second flexible frame member having an exposed portion, and wherein the harness is movably coupled to the exposed portion of the second flexible frame member to allow for movement of the pack body relative to the harness.

3. The utility pack of claim 2, wherein the harness includes a shoulder harness having two or more straps that engage the wearer's shoulders and a waist harness having opposing portions adapted to at least partially encircle a wearer's waist.

4. The utility pack of claim 3, wherein the shoulder harness includes a shoulder harness guide sized to movably engage the exposed portion of the second flexible frame member and thereby allow for the movement of the pack body relative to the shoulder harness.

5. The utility pack of claim 3, wherein the second flexible frame member includes opposing ends;
wherein the waist harness has opposing receivers disposed therein; and
wherein the opposing ends of the second flexible frame member engage the waist harness receivers.

6. The utility pack of claim 5, wherein the first flexible frame member has opposing ends that engage the waist harness receivers.

7. The utility pack of claim 3, further comprising a cross brace coupled between the pack body and the waist harness.

8. The utility pack of claim 1, wherein the harness is a waist harness having opposing portions adapted to at least partially encircle a wearer's waist, and further comprising:
a second flexible frame member disposed about at least a portion of the pack back side, the first and second flexible frame members each having opposing ends;
a cross brace coupled between the pack body and the waist harness;
wherein the waist harness includes a plurality of opposing receivers disposed therein; and
wherein the opposing ends of the first and second flexible frame members engage the waist harness receivers.

9. The utility pack of claim 1, wherein the flexible frame members include:
an outer rod having a first outer diameter and made of a first material, the outer rod having an aperture disposed therein having an inner diameter; and
one or more inner rods made of a second material having a second outer diameter that is less than the inner diameter of the outer rod aperture.

10. The utility pack of claim 9, wherein the inner rod is made of a fiber reinforced composition including fiberglass, carbon fiber and/or aramid fiber, and the outer rod is made of any one or more materials selected from the group consisting of nylon, polyurethane, polyethylene, polypropylene, and polycarbonate.

11. The utility pack of claim 9, wherein the outer rod first outer diameter is in the range of approximately 5.00-5.12 mm, the outer rod aperture inner diameter in the range of approximately 1.95-2.05 mm, and the inner rod second outer diameter in the range of approximately 1.75-1.85 mm.

12. The utility pack of claim 1 wherein the first flexible frame member includes a portion that generally tracks the pattern of access port, wherein the first flexible frame member portion may help bias the access port in the open and/or closed position.

13. A method of forming a utility pack, comprising:
providing a pack body composed at least in part of a pliable material, and having a plurality of guides disposed thereon;
providing a plurality of flexible frame members; and
structurally forming the pack by inserting the flexible frame members in the plurality of guides in the pack body.

14. The method of claim 13, wherein providing the plurality of flexible frame members includes:
coupling a first flexible frame member to a pack front side by engaging guides disposed on the pack front side;
coupling a second flexible frame member to a pack back side by engaging guided disposed on the pack back side; and
providing a harness coupled to the pack body, wherein the pack body is adapted to couple the pack to a wearer's body.

15. The method of claim 14, wherein the first and second flexible frame members include opposing ends and the harness is a waist harness, the method further comprising coupling the opposing ends of the first and second flexible frame members to corresponding opposing sides of the waist harness.

16. The method of claim 15, further comprising coupling a cross brace between the pack body and the waist harness.

17. The method of claim 15, further comprising:
providing a shoulder harness having one or more harness guides;
exposing one or more portions of the second flexible frame member;
coupling the harness guides to the one or more exposed portions of the second flexible frame member to allow for movement of the pack body relative to the shoulder harness.

18. A flexible frame member for structure forming applications, comprising:
an outer rod having a hollow portion; and
an inner rod made of a fiber-reinforced composition and further disposed in the hollow portion.

19. The flexible frame member of claim 18, wherein the outer rod is made of any one selected from the group consisting of nylon, polyurethane, polyethylene, polypropylene, and polycarbonate.

20. The flexible frame member of claim 19, wherein the outer rod further comprises an additive selected from the group consisting of a reinforcement material, a filler, a heat-resistant stabilizer, a weatherproof stabilizer, a slip agent, a nucleating agent, a fire retardant, color pigment, and dye.

21. The flexible frame member of claim 18, wherein the inner rod is made of 60-65 w % of fiber reinforcement material, 28-32 wt % of solvent, and 3-7 wt % of additive.

22. The flexible frame member of claim 21, wherein the fiber reinforcement material includes fiberglass, carbon fiber, and/or aramid fiber.

23. The flexible frame member of claim 21, wherein the solvent is polyester or benzene.

24. The dual-structured rod member of claim 1, wherein the outer rod has an outer diameter of 5.00-5.12 mm, the hollow portion of the outer rod has a diameter of 1.95-2.05 mm and the inner rod has a diameter of 1.75-1.85 mm.

25. The flexible frame member of claim 18, wherein two or more inner rods are inserted into the hollow portion of the outer rod.

26. The utility pack of claim 1, wherein the flexible frame members are configured to include one or more endless loops.
